(19) United States
(12) Patent Application Publication
(10) Pub. No.: US 2008/0016835 A1
(43) Pub. Date: Jan. 24, 2008

(54) Nestable, rigid, planar air filter frame

(76) Inventors: Thomas A. Justice, (US); James B. Mercer, (US)

Correspondence Address: NIXON PEABODY, LLP, 401 9TH STREET, NW, SUITE 900, WASHINGTON, DC, 20004-2128, US

(21) Appl. No.: 11/543,221

(22) Filed: Oct. 5, 2006

Related U.S. Application Data
(63) Continuation-in-part of application No. 11/453,989, filed on Jun. 16, 2006.

(51) Int. Cl. B01D 46/10

(52) U.S. Cl. 55/501; 55/495

(57) ABSTRACT

A nestable frame for planar air filters or other screen-like planar structures. The nestable frame provides all of the following desirable properties at once: 1. Simple manufacturing and assembly process, 2. Simple design, 3. Enhanced structural rigidity, 4. Significant space-savings during storage and transport, and 5. Simple handling. The filter frame comprises an upper and a lower frame portion with a first leg each, where the peripheral edge of the filter media is clampingly engaged between the first leg of the upper frame portion and the first leg of the lower frame portion. From the first leg, both frame portions extend outwardly with a second leg at an obtuse angle. The frame portions are connected at the outer ends of their second legs with a connecting leg. Alternative embodiments contain straight connection legs at different angles, curved connection legs or a multitude of connection legs, oriented to the outside of the frame or collapsed inwardly into the frame, for various purposes. Yet alternative embodiments include various values for the obtuse angles between the first and second legs of the upper and lower frame portion. While same angles between corresponding legs of both frame portions may allow for easier design of the frame, a larger angle in the lower frame portion may allow for greater rigidity of the frame at the level of the plane of the filter medium.

### BACKGROUND OF THE INVENTION

1. Field of the Invention

The present invention relates generally to air filters and, more particularly, to a nestable frame for planar air filters or other screen-like planar structures.

2. Description of the Prior Art

Filters are typically provided in beating, ventilating and air conditioning equipment upstream of the air handler for removing particulate impurities from the air principally in order to protect the equipment, and secondarily to remove particulate impurities from the air circulated within homes, offices and industrial environments that affect the indoor air quality to which people are exposed. Such filters are also used for removing impurities entrained in air or another gas prior to release of the gas into the atmosphere. Various industrial processes also use filters for removing particulates from gases or other fluids.

Filters are typically formed by mounting a panel of a filter medium, such as a fibrous mat or porous foam or a pleated panel of a filter medium to reduce the relative pressure drop, within a surrounding support frame. The frame supports the filter medium in a relatively planar shape and provides mechanical strength for retaining the filter in a manner which is not only mechanically secure but also seals well to its associated machinery so that all of the fluid flow is directed through the filter medium.

It is desirable for a filter to be inexpensive and have sufficient strength and durability. It is also desirable to maximize the effective filtering area of a filter and to permit the compact packaging of multiple filters for efficient distribution and storage.

Generally, prior art in the field of air filters relates to three different types of devices:

a) Filters with a box-like frame and a three-dimensional arrangement of filter media

b) Filters with a planar frame that is essentially incompressible and

c) Filters that consist of a planar frame that is compressible, collapsible or nestable perpendicular to the planar filter media, so that multiple filters can be stacked tightly during storage and transport prior to usage.

Relevant prior art to the present invention relates to type c) of filter frames.

A basic example of a stackable planar filter was disclosed in U.S. Pat. No. 3,970,440 issued Jul. 20, 1976, to Copenhefer, et al. for a Compact Air Filter. This planar air filter comprises a frame formed of an integral suitable cut and scored blank of paperboard, which, when assembled, comprises planar frame members engaging a substantially sheet-form filter element there between. Attached to the planar frame members, the disclosed frame has flared frame members disposed at an angle of less than 180 degree permitting a plurality of frames to nest within each other, thereby reducing the bulk of the plurality of filters. More sophisticated prior art subsequent to this patent is cited below with brief abstract statements summarizing the main points for each reference:

U.S. Pat. No. 4,068,071 issued Apr. 25, 1978, to Champlin, assigned to Packaging Corporation of America, for Air filter assembly, describes an air filter that contains a multisided supporting frame. The frame includes a foraminous center section, a marginal section delimiting the center section, and flanges connected to the marginal section. The center and marginal sections are in supporting engagement with one surface of the filter panel. The flange segments are foldably connected to the marginal sections and extend angularly inwardly therefrom forming an acute angle with the corresponding marginal sections. The construction of the frame enables the filter assembly to assume a collapsed state so that a plurality of such assemblies can form a compact bundle for shipping and/or storage.

U.S. Pat. No. 4,105,423 issued Aug. 08, 1978, to Latakas, et al. for a Compact air filter with tubular frame, describes a compact nestable air filter comprising a frame formed of an integral suitable cut and scored blank of paperboard. The assembled frame comprises planar frame members engaging a sheet-form filter element there between, and has flared frame members disposed at an angle of less than 180 degree permitting a plurality of completed filters to nest within each other, thereby reducing the bulk of the plurality of filters. The flared frame members have a tubular contour, greatly increasing their strength and rigidity.

U.S. Pat. No. 4,372,763 issued Feb. 08, 1983, to Champlin, et al. for an Air filter assembly, describes an air filter assembly comprising a compressible air pervious multi-sided filter panel and a frame therefor. The frame is adjustable from a collapsed mode to an operative mode. The frame of foldable sheet material includes a foraminous center section in supporting engagement with the filter panel; a marginal section delimiting the center section; and a plurality of elongated peripheral sections foldably connected to the marginal sections. The peripheral and the marginal sections form a hollow verge encompassing the filter panel periphery when the frame is in the operating mode. The peripheral sections form a substantially flat multiply flange overlapping and compressing the filter panel periphery when the frame is collapsed. When the frame is adjusted from the collapsed mode to the operating mode, the overlapped end portions of the peripheral sections will abuttingly engage at an angle and restrain movement of the frame from the operating mode back to the collapsed mode.

U.S. Pat. No. 4,636,233 issued Jan. 13, 1987, to Lizmore for a Filter assembly, describes a filter assembly including a casing with a support panel to support the filter element and upstanding walls extending around the periphery of the casing. The walls are inclined to the support panel to permit nesting of the casings during transport.

U.S. Pat. No. 5,800,588 issued Sep. 01, 1998, to Miller for a Nestable, rigid filter frame describes a filter with a nestable frame. The frame includes a first leg, a second leg extending obtusely from the first leg, and a third leg extending from the second leg and forming a channel between the second and third legs. The filter also includes a brace with similar first, second and third legs. The brace is mounted to the frame, with its second and third legs extending into the channel of the frame. A chamber is formed by the second and third legs of the frame and the second and third legs of the brace. The chamber is preferably filled with material which rigidities the box beam structure formed by the walls surrounding the chamber. A filter medium material attaches to the frame, by adhesion and/or by clamping engagement between the first legs of the frame and brace.

U.S. Pat. No. 6,033,454 issued Mar. 07, 2000, to Hoeffken for an Air filter assembly, describes a filter frame with planar surfaces and rails along outer edges of the planar surfaces. The rails flare outwardly at an obtuse angle from the plane when the frame is unconfined One of the rails at each corner of the rectangular frame is provided with tabs, and the other rail at the corner has an open end into which the tab extends. The tabs are slidable to enable collapsing of the rails for transport but confined by their geometry to prevent disengagement of the rails when the frame is assembled.

None of the prior art provide a frame with all of the following desirable properties: 1) simple manufacturing and assembly process, 2) simple design, 3) enhanced structural rigidity, 4) significant space-savings during storage and transport, 5) simple handling, and 6) lower material handling and packaging costs. A combination of all these functionalities is desired, because all simplicity aspects and space savings result in cost-savings, and structural rigidity of the frame is required for quality purposes.

Filter frames in prior art that provide for sufficient frame stability contain tubular profiles or voids that make the frame complex and difficult to manufacture. A geometrically simple, easy-to-manufacture, and easy-to-assemble void enclosed in the frame would provide for enhance structural rigidity at reasonable cost.

Filter frames in prior art with only one frame leg extending from the planar filter media are simple in design but do not provide sufficient rigidity.

Filter frames that can be stacked tightly in a collapsed mode, and become rigid by unfolding them to the operating mode, require additional attention after packaging and transport, and therefor increase operating cost.

Thus, there remains a need for a stackable filter frame that is cost-efficient in manufacture and operation, and simple in design, can be compactly stacked during storage and transport, and yet exhibits structural rigidity to provide a high-quality product.

### SUMMARY OF THE INVENTION

The present invention is directed to a planar, nestable air filter with several variations in frame geometry capable of providing a simple, stable frame for planar air filter panels. The frame design described is cost-effective in manufacturing arid operation, and allows for savings in storage, transportation, material handling labor, and packaging costs, since the volume is reduced significantly when several air filters are packaged together. In addition, the frame geometry including a simple, structurally enclosed void, provides sufficient rigidity to result in a high-quality filter.

In a preferred embodiment, the filter frame comprises an upper and a lower frame portion with a first leg each. The peripheral edge of the filter media is clamped, adhered, or with other suitable means engaged between the first leg of the upper frame portion and the first leg of the lower frame portion. From the first leg, both, upper and lower frame portion extend outwardly at an obtuse angle with a second leg. At the outward ends of their second legs, the upper and the lower frame portion connect via at least one additional frame leg. The opposing surfaces of the second leg of the upper frame portion, the vertical leg of the middle frame portion, and the second leg of the lower frame portion define a hollow space in-between.

The angles between the first and the second legs of both the upper and lower frame portions are obtuse. This is significantly different from prior art and important, because it allows for nesting of the filter frames. Furthermore, the angle of the lower frame portion is always equal or larger than the angle of the upper frame portion. This is significantly different from prior art and important, because it increases the rigidity of the frame specifically and effectively at the connection point between the first and the second legs of the frame portions, which is most important for overall frame stability.

In alternative embodiments, the angle between the first and second leg of the lower frame portion may be equal or larger than the angle between the first and second leg of the upper frame portion. In yet alternative embodiments, the connection leg between upper and lower frame portion, may be vertical, horizontal, or at a suitable angle. In yet an alternative embodiment, there may be two or more connecting legs between the upper and lower frame portion or the connecting leg may have a shape other than straight.

These and other aspects of the present invention will become apparent to those skilled in the art after a reading of the following description of a preferred embodiment when considered with the drawings.

### BRIEF DESCRIPTION OF THE DRAWINGS

FIG. 1 is a perspective illustration of a planar air filter comprising the nestable frame in a first preferred form of the invention.

FIG. 2 is a view in vertical section taken substantially along the line 2-2 of FIG. 1 illustrating a segment of the filter of FIG. 1.

FIG. 3 through 15 are views in section illustrating alternative filter frames embodying the present invention.

FIG. 16 is a view in section similar to the section of FIG. 2, but illustrating a plurality of stacked filters in a package.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” “horizontal,” “vertical,” and the like are words of convenience and are not to be construed as limiting terms.

Referring now to the drawings in general, the illustrations are for the purpose of describing a preferred embodiment of the invention and are not intended to limit the invention thereto.

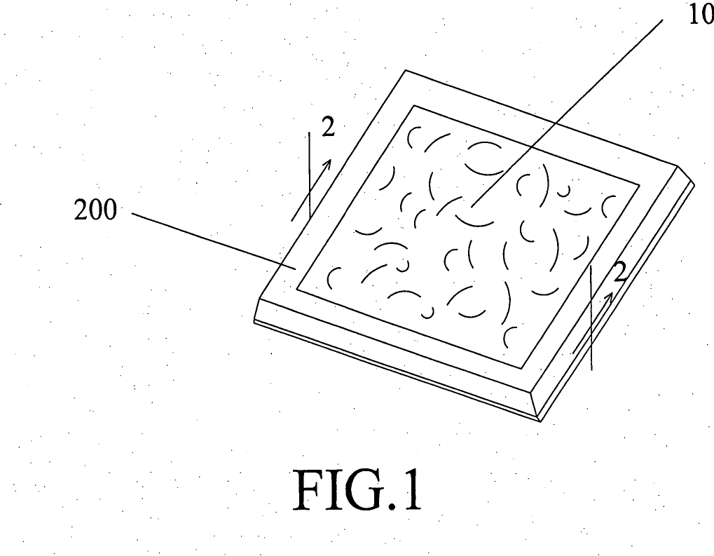

FIG. 1 shows a perspective illustration of the filter. The filter comprises a planar panel of filter medium, 100, which is delimited to all sides by the surrounding periphery 101. The surrounding periphery of the filter medium is held within the filter frame 200. Preferably, the frame member may be made of cardboard. Alternatively, the frame member could be made of thermoformed polystyrene, PVC, paperboard, or similar materials.

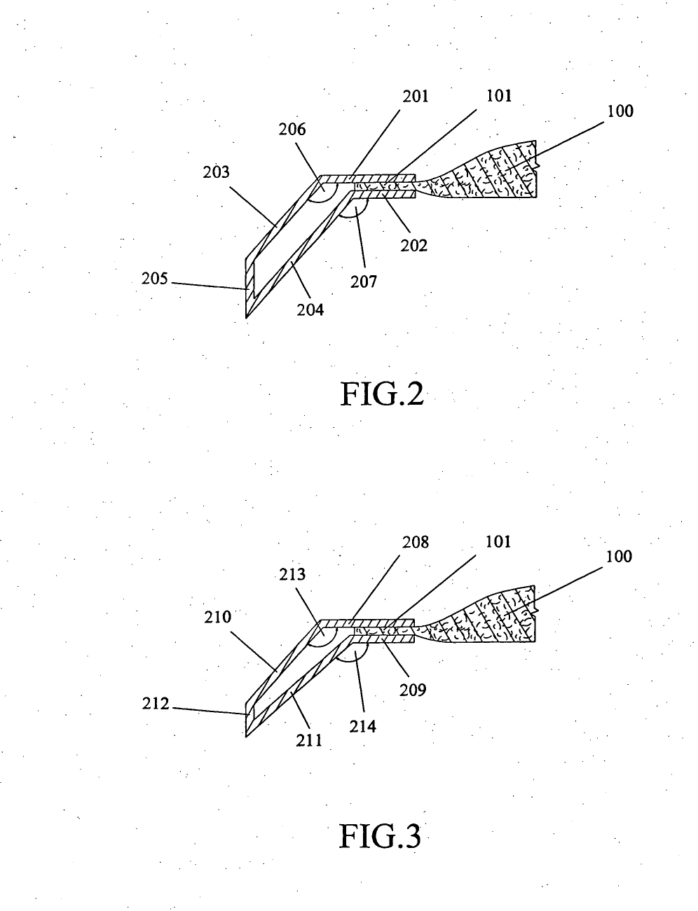

FIG. 2 shows a cross-sectional view of the filter in FIG. 1 along the line 2-2. In this preferred embodiment, the filter frame 200 consists of a first leg of an upper frame portion, 201, and a first leg of a lower frame portion 202, which form an overlapping sandwich composite with the surrounding periphery of the filter medium, 101, in a clamp-like action. This clamp-like action is for example achieved by means of adhesion, friction or bonding.

From the first leg 201, the upper frame portion extends outwardly from the filter panel periphery 101 with a second leg 204, at an obtuse angle to the first leg, 206. The second leg of the lower frame portion, 204, extends outwardly from the filter medium periphery 101 at the obtuse angle 207, which is equal to the obtuse angle 206 between the first and second leg of the upper frame portion. The second legs of the upper and lower frame portions are connected at their outward ends by a middle frame portion made of a vertical leg 205. The frame member's cross section is preferably a unitary, integral, continuous piece of contiguous material; in other words, the upper, middle, and lower frame portions are preferably made from one contiguous piece of material. The opposing surfaces of the second leg of the upper frame portion 203, the vertical leg of the middle frame portion 205, and the second leg of the lower frame portion 204 define a hollow space in-between.

This cross-sectional frame shape provides a rigid structure to prevent collapsing and twisting of the frame and allows the nesting of multiple frames and therefore filters in vertical direction. In addition, the frame structure is easily foldable from one single blank of card board or other suitable sheet material.

FIG. 3 shows a design variation of the filter frame 200. In this embodiment, the shape is essentially the same as in FIG. 2, but the obtuse angle between the first and second leg of the lower frame portion, 214, is greater than the obtuse angle between the first and second leg of the upper frame portion, 213.

This design allows for greater rigidity of the frame in its top portion in the plane of the filter medium, in comparison to the rigidity in the frames bottom portion. This is caused by the larger area of the void in the top of the frame portion versus the area of void in the bottom portion of the frame.

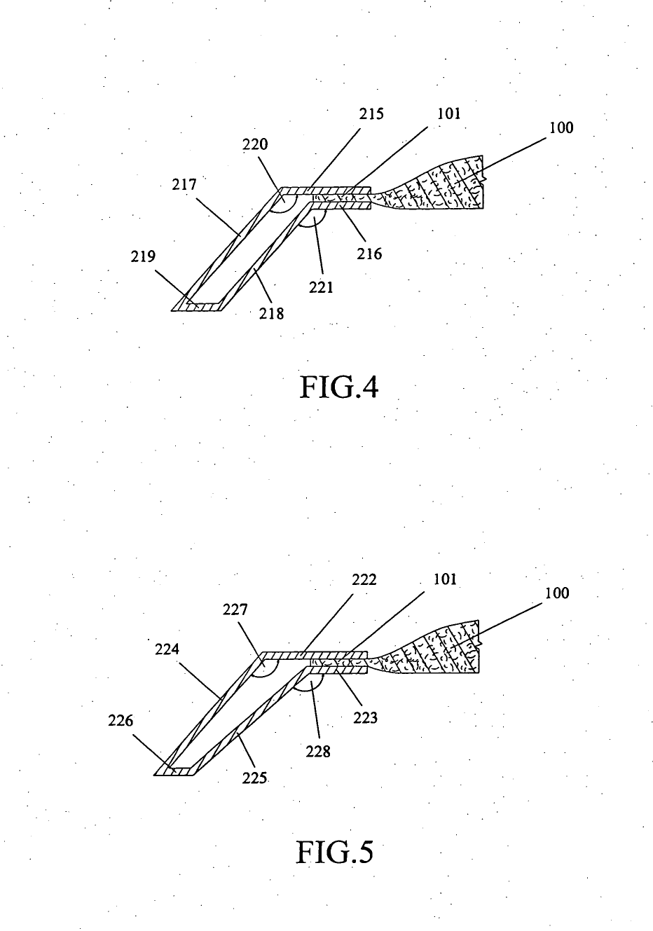

FIG. 4 shows another design variation. In this embodiment, the shape is essentially the same as in FIG. 2, but the connecting leg 219 is horizontal.

FIG. 5 shows yet another design variation. In this embodiment, the shape is essentially the same as in FIG. 3, but the connecting leg 226 is horizontal.

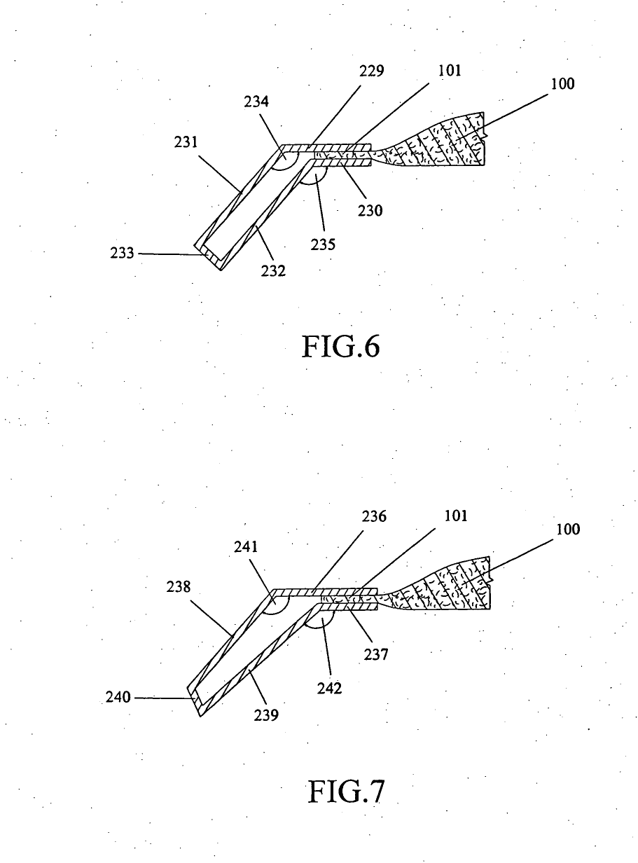

FIG. 6 and FIG. 7 are design variations of FIG. 2 and FIG. 3, with the difference that the connection legs in each variation, 233 and 240, are angled suitably to provide simple production and assembly, as well as good stability of the frame.

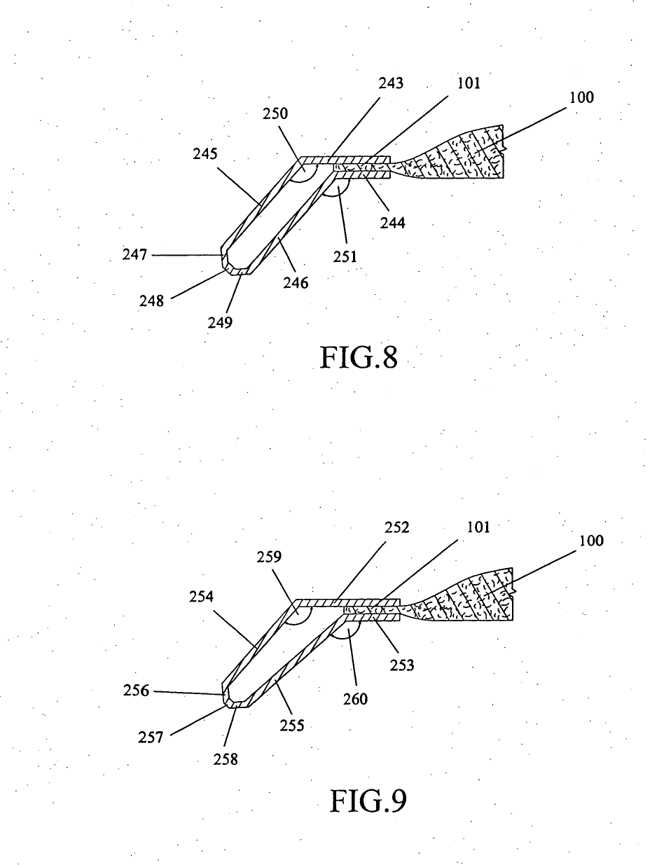

FIG. 8 shows a design variation where the connection of the second legs of the upper and lower frame portion is accomplished by more than one leg, in the exemplary drawing shown as a combination of three legs 247, 248 and 249. The advantage of this construction is that the area of the void, and thus the rigidity, in the part of the frame planar with the filter medium is essentially kept constant, while the lower part of the frame is somewhat flexible, with hinge-like, folded connections between the legs. The frame profile in the lower section of the frame may slightly adjust to the needs during transportation and use of the filter.

FIG. 9 shows a design similar to the one in FIG. 8, but the obtuse angle between the first and second leg of the lower frame portion, 260, is larger than the obtuse angle between the first and second leg of the upper frame portion, 259, to provide more rigidity in the upper part of the frame.

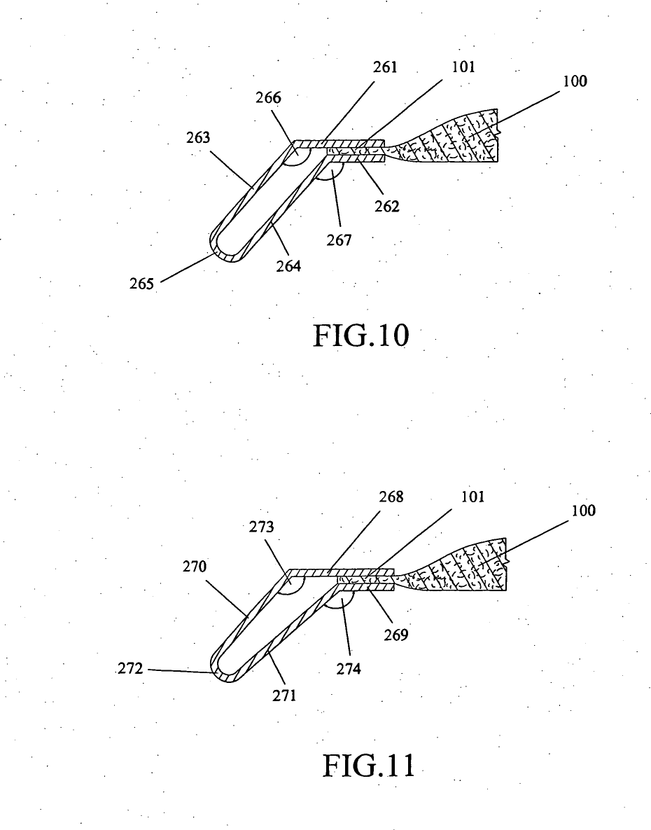

FIG. 10 shows a preferred embodiment where the connection of the upper frame portion and the lower frame portion is accomplished with a curved connection leg 265 that is convex with respect to the frame. As in the design of FIG. 8, this allows for flexibility in the frame in the lower frame portion, while keeping the upper frame portion rigid. In addition, the curved or rounded leg does not require an actual scoring and folding line and allows for adjustments in the fit of the first legs of upper and lower frame portion. Therefore, this design is extremely simple to manufacture and assemble.

FIG. 11 shows essentially the same design as FIG. 10, but the obtuse angle between the first and the second leg of the lower frame portion, 274, is larger than the obtuse angle between the first and the second leg of the upper frame portion, 273. This design allows for increased rigidity of the frame at the level of the planar filter medium.

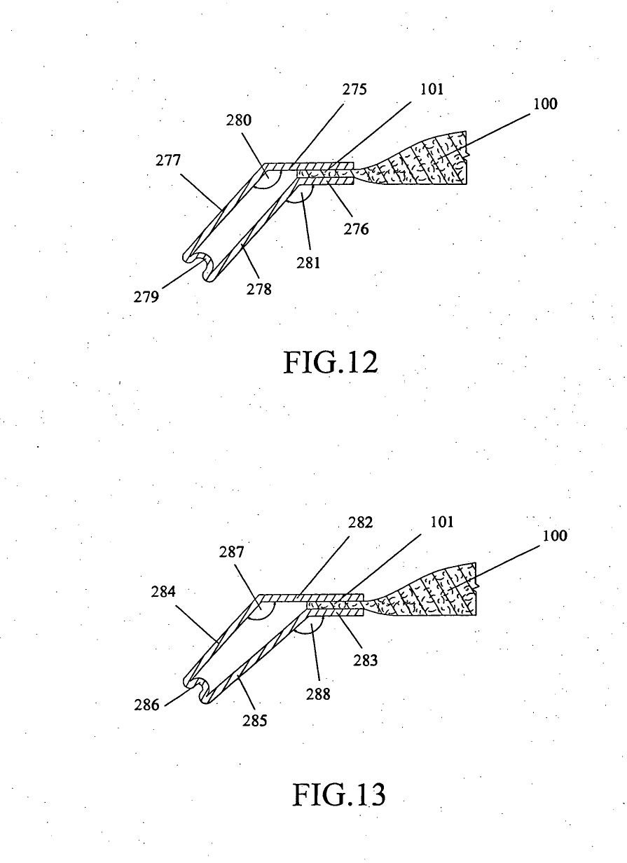

FIG. 12 shows the design of FIG. 10, but the curved connection leg 279 is collapsed inwardly (concave) to the frame. This design allows for even more flexibility in the lower part of the frame, for transport and storage versus usage.

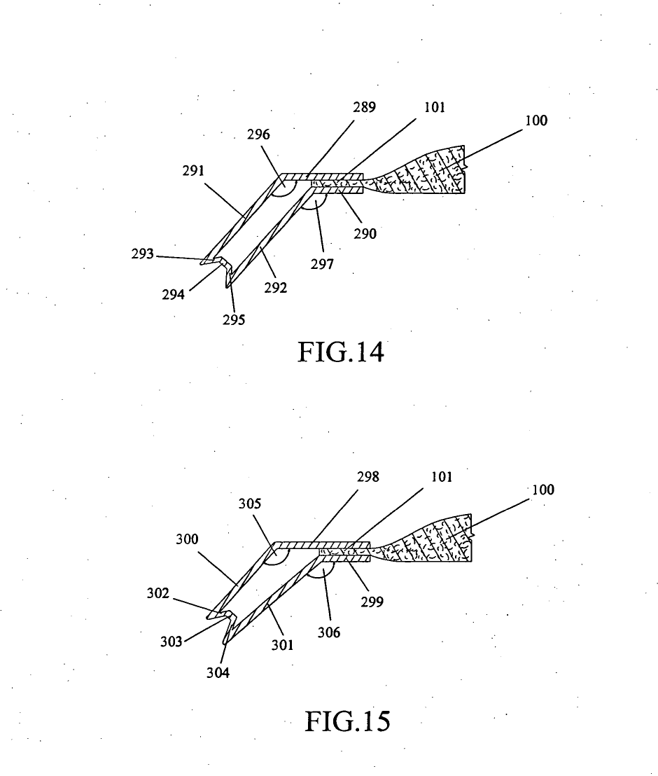

FIG. 13 shows a preferred embodiment similar to FIG. 12, but the obtuse angle between the first and the second leg of the lower frame portion, 288, is larger than the obtuse angle between the first and second leg of the upper frame portion, 287.

FIG. 14 shows the design of FIG. 8, but the multiple connection legs 293, 294 and 295 are collapsed inwardly (to the frame. This design allows for even more flexibility in the lower part of the frame, for transport and storage versus usage.

FIG. 15 shows a preferred embodiment similar to FIG. 14, but the obtuse angle between the first and the second leg of the lower frame portion, 306, is larger than the obtuse angle between the first and second leg of the upper frame portion, 305.

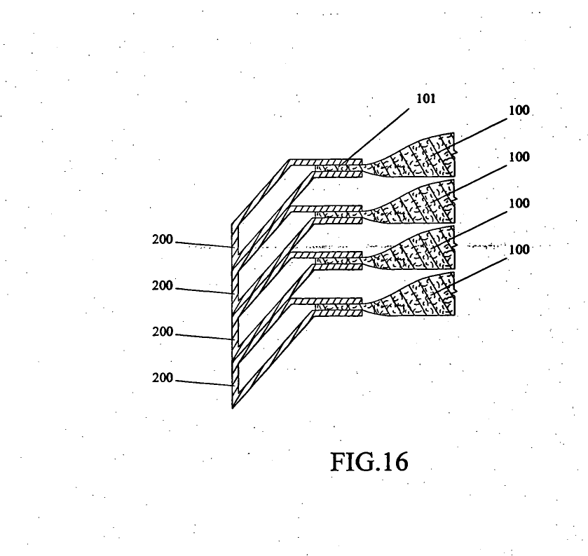

FIG. 16 shows by example of the frame design of FIG. 2, how multiple filters can be stacked normal to the filter panel plane, further referred to as vertically, and nested in such a way that they take significantly less space vertically than the same number of filters would take if they were not nested, but stacked on top of each other.

Certain modifications and improvements will occur to those skilled in the art upon a reading of the foregoing description. All modifications and improvements have been deleted herein for the sake of conciseness and readability but are properly within the scope of the following claims.

What is claimed is:

1. A filter frame having a cross-section comprising:
a. an upper, middle, and a lower frame portion;
b. wherein the upper frame portion comprises a first leg and a second leg extending at a first obtuse angle from the first leg;
c. wherein the lower frame portion comprises a first leg and a second leg extending at a second obtuse angle from the first leg;
d. wherein the middle frame portion comprises at least one leg, the at least one leg connecting the second leg of the upper frame portion to the second leg of the lower frame portion;
e. wherein the first legs of both the upper and lower frame portions are parallel to each other; and
f. wherein the at least one leg of the middle frame portion and the second legs of the upper and lower frame portions define a hollow space.

2. The filter frame of claim 1, wherein the first obtuse angle is approximately. equivalent to the second obtuse angle.

3. The filter frame of claim 1, wherein the first obtuse angle is smaller than the second obtuse angle.

4. The filter frame of claim 1, wherein the second obtuse angle is larger than the first obtuse angle.

5. The filter frame of claim 1, wherein the at least one leg of the middle frame portion is one leg that is approximately perpendicular to the first leg of the upper frame portion.

6. The filter frame of claim 1, wherein the at least one leg of the middle frame portion is one leg that is approximately parallel to the first leg of the upper frame portion.

7. The filter frame of claim 1, wherein the at least one leg of the middle frame portion is one leg that is angled with respect to the first leg of the upper frame portion.

8. The filter frame of claim 1, wherein the at least one leg of the middle frame portion is comprised of three legs.

9. The filter frame of claim 1, wherein the at least one leg of the middle frame portion is comprised of a curved leg.

10. The filter frame of claim 1, wherein the at least one leg of the middle frame portion is comprised of a convex curved leg.

11. The filter frame of claim 1, wherein the at least one leg of the middle frame portion is comprised of a concave curved leg.

12. The filter frame of claim 1, wherein the upper, middle, and lower frame portions are made of one contiguous piece of material.

13. The filter comprising:
a. a filter medium having at least one peripheral edge and first and second opposite major faces; and
b. a frame member surrounding the at least one peripheral edge of the filter medium panel, the frame having a cross-section comprising:
i. an upper, middle, and a lower frame portion;
ii. wherein the upper frame portion comprises a first leg and a second leg extending at a first obtuse angle from the first leg;
iii. wherein the lower frame portion comprises a first leg and a second leg extending at a second obtuse angle from the first leg;
iv. wherein the middle frame portion comprises at least one leg, the at least one leg connecting the second leg of the upper frame portion to the second leg of the lower frame portion;
v. wherein the first legs of both the upper and lower frame portions are parallel to each other; and
vi. wherein the at least one leg of the middle frame portion and the second legs of the upper and lower frame portions define a hollow space.

14. The filter of claim 13, wherein the second obtuse angle is larger than the first obtuse angle.

15. The filter of claim 13, wherein the frame member is made from one contiguous piece of material.
